(19) United States
(12) Patent Application Publication
(10) Pub. No.: US 2012/0126454 A1
(43) Pub. Date: May 24, 2012

(54) BLOCK COPOLYMERS COMPRISING POLY(1,3-TRIMETHYLENE TEREPHTHALATE) AND POLY(1,3-TRIMETHYLENE 2,6-NAPHTHALATE)

(75) Inventor: Alexandra Hedy SIMMONS, Elginburg (CA)

(73) Assignee: E. I. DU PONT DE NEMOURS AND COMPANY, Wilmington, DE (US)

(21) Appl. No.: 13/299,582

(22) Filed: Nov. 18, 2011

Related U.S. Application Data
(60) Provisional application No. 61/415,963, filed on Nov. 22, 2010.

(51) Int. Cl. C08G 63/00; B29C 55/00

(52) U.S. Cl. 264/291; 525/419

(57) ABSTRACT

Disclosed are a composition, an article comprising the composition, and a process for producing the composition. The composition comprises a block copolymer, which comprises or is produced from poly(1,3-trimethylene terephthalate) sequences and poly(1,3-trimethylene naphthalate) sequences with less than 50 wt % of poly(1,3-trimethylene naphthalate) and the process comprises combining poly(1,3-trimethylene terephthalate) and poly(1,3-trimethylene 2,6-naphthalate) under controlled transesterification to produce the composition.

This application claims priority to U.S. provisional application Ser. No. 61/415,963, filed Nov. 22, 2010; the entire disclosure of which is incorporated herein by reference.

The invention is directed to a process to provide films or other oriented structures incorporating controlled transesterification of blends of poly(1,3-trimethylene terephthalate) and poly(1,3-trimethylene 2,6-naphthalate), block copolymer compositions produced thereby, and films and other oriented structures comprising said compositions.

### BACKGROUND OF THE INVENTION

This invention relates to block copolymers of 1,3-trimethylene terephthalate and 1,3-trimethylene 2,6-naphthalate, formed by controlled esterification of the homopolymers. By employing controlled esterification, copolymers which exhibit properties consistent with block copolymer formation are made.

Physical blends and random copolymers of poly(1,3-trimethylene terephthalate) and poly(1,3-trimethylene 2,6-naphthalate) are generally known. Jeong, et al., in Fibers and Polymers 2004, 5(3), 245-251, and Lorenzetti, et al., in Polymer 2005, 46, 4041-4051, describe random copolymers of 1,3-trimethylene terephthalate and 1,3-trimethylene 2,6-naphthalate. U.S. Pat. No. 6,531,548 describes physical blends of poly(1,3-trimethylene terephthalate) and poly(1,3-trimethylene 2,6-naphthalate) made by processing under conditions which allow physical mixing only. US2007/0232763 describes blends of poly(1,3-trimethylene 2,6-naphthalate) with poly(ethylene terephthalate), but does not include blends with poly(1,3-trimethylene terephthalate).

It is an object of the present invention to provide block copolymers of 1,3-trimethylene terephthalate and 1,3-trimethylene 2,6-naphthalate by controlled esterification of blends of the homopolymers and provide films or other oriented structures which exhibit clarity and acceptable oxygen transmission rates.

### SUMMARY OF THE INVENTION

The invention relates to a process, comprising combining poly(1,3-trimethylene terephthalate) and poly(1,3-trimethylene 2,6-naphthalate) to form a blend containing up to 50, or about 1 to about 49, wt % poly(1,3-trimethylene 2,6-naphthalate); feeding said blend into an extruder; and producing a film comprising block copolymers containing poly(1,3-trimethylene terephthalate) sequences and poly(1,3-trimethylene 2,6-naphthalate) sequences by said extruder at a temperature between about 275° C. and about 300° C. and a residence time of between about 3 to about 7 minutes; wherein transesterification can occur between said poly(1,3-trimethylene terephthalate) and poly(1,3-trimethylene 2,6-naphthalate) at a level of about 0.5% to about 10% such that the formed film has a percent transmittance of over 85% or 90%, an oxygen permeation at a relative humidity of 0 of between 3 and 7.5 cc-mil/100 in²-day, and a degree of 1.0 randomness of less than about 0.15.

The invention also relates to a process as described above, wherein the cast film is stretched biaxially at a stretch ratio of greater than about 3.0×3.0 at 9,000%/min, followed by heat-setting under tension of the biaxially-stretched film at a temperature of between about 150° C. and about 200° C. producing the film exhibiting increased density which typically results from crystallization under these conditions. The present invention also relates to the above-described processes wherein at least one of poly(1,3-trimethylene 2,6-terephthalate) and poly(1,3-trimethylene naphthalate) is preferably derived from a biological source.

The invention further relates to films with copolymer compositions comprising poly(1,3-trimethylene terephthalate) and up to 50 wt % poly(1,3-trimethylene 2,6-naphthalate), having a percent transmittance of greater than 85% or 90%, an oxygen permeability at a relative humidity of 0 of between 3 and 7.5 cc-mil/100 in²-day, and a degree of randomness of less than about 0.15 when formed into a film of a thickness of about 10 mil before biaxially stretching or heat setting.

One or both of the components of the copolymer may be derived from a biological source.

### DETAILED DESCRIPTION OF THE INVENTION

The following definitions are used herein to further define and describe the disclosure.

As used herein, the terms “comprising,” “comprises, ” “includes,” “including,” “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting essentially of” limits the scope of a claim to the specified materials or steps and those that do not materially affect the basic and novel characteristic(s) of the claimed invention.

Where applicants have defined an invention or a portion thereof with an open-ended term such as “comprising,” it should be readily understood that unless otherwise stated the description should be interpreted to also describe such an invention using the terms “consisting essentially of” and “consisting of”.

As used herein, the articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

When the term “about” is used in describing a value or an end-point of a range, the disclosure should be understood to include the specific value or end-point referred to or stated.

Unless stated otherwise, all percentages, parts, ratios, etc., are by weight.

The term “copolymer” is used herein to refer to polymers containing copolymerized units of two different monomers (i.e. a dipolymer), or more than two different monomers (e.g. a terpolymer, tetrapolymer or higher order polymer).

Finally, when materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

As indicated above, the copolymer comprises an amount of a poly(1,3-trimethylene terephthalate) sequences and an amount of poly(1,3-trimethylene 2,6-naphthalate) sequences.

Poly(trimethylene terephthalate)s suitable for use are well known in the art, and conveniently prepared by polycondensation of 1,3-propanediol with terephthalic acid or terephthalic acid equivalent, such as dimethyl terephthalate.

By “terephthalic acid equivalent” is meant compounds that perform substantially like terephthalic acids in reaction with diols, as would be generally recognized by a person of ordinary skill in the relevant art. Terephthalic acid equivalents for the purpose of the present invention include, for example, esters (such as dimethyl terephthalate), and ester-forming derivatives such as acid halides (e.g., acid chlorides) and anhydrides.

All references disclosed are incorporated herein by reference.

Preferred are terephthalic acid and terephthalic acid esters, more preferably the dimethyl ester. Methods for preparation of poly(trimethylene terephthalate)s are discussed, for example in U.S. Pat. No. 6,277,947, U.S. Pat. No. 6,326,456, U.S. Pat. No. 6,657,044, U.S. Pat. No. 6,353,062, U.S. Pat. No. 6,538,076, US2003/0220465A1 and commonly owned U.S. patent application Ser. No. 11/638,919 (filed 14 Dec. 2006, entitled “Continuous Process for Producing Poly(trimethylene Terephthalate)”).

The 1,3-propanediol for use in making the poly(trimethylene terephthalate) is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol have been described that utilize feedstocks produced from biological and renewable resources such as corn feedstock. For example, bacterial strains able to convert glycerol into 1,3-propanediol are found in the species Klebsiella, Citrobacter, Clostridium, and Lactobacillus. The technique is disclosed in several publications, including previously incorporated U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterogonous pdu diol dehydratase gene, having specificity for 1,3-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The poly(trimethylene terephthalate) based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention prepared using biologically derived 1,3-propanediol can be characterized as more natural and having less environmental impact than similar compositions comprising petroleum based diols.

The biologically-derived 1,3-propanediol, and poly(trimethylene terephthalate) or poly(trimethylene 2,6-naphthalate) based thereon, may be distinguished from similar compounds produced from a petrochemical source or from fossil fuel carbon by dual carbon-isotopic finger printing. The methods to determine this are outlined in Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74); Hsieh, Y., Soil Sci. Soc. Am J., 56, 460, (1992); and Weber et al., J. Agric. Food Chem., 45, 2042 (1997).

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making poly(trimethylene terephthalate) or poly(trimethylene 2,6-naphthalate) will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

Poly(trimethylene terephthalate)s useful in this invention can be poly(trimethylene terephthalate) homopolymers (derived substantially from 1,3-propanediol and terephthalic acid and/or equivalent) and copolymers, by themselves or in blends. Poly(trimethylene terephthalate)s preferably contain about 70 mole % or more of repeat units derived from 1,3-propanediol and terephthalic acid (and/or an equivalent thereof, such as dimethyl terephthalate).

The poly(trimethylene terephthalate) used can be prepared by the condensation polymerization of 1,3-propanediol and terephthalic acid or from 1,3-propanediol and dimethylterephthalate (DMT) in a two-vessel process using tetraisopropyl titanate catalyst, TYZOR® TPT (a registered trademark of E. I. du Pont de Nemours and Company). For example, molten DMT is added to 1,3-propanediol and catalyst at about 185° C. in a transesterification vessel and the temperature is increased to 210° C. while methanol is removed. The resulting intermediate is then transferred to a polycondensation vessel where the pressure is reduced to one millibar (10.2 kg/cm²), and the temperature is increased to 255° C. When the desired melt viscosity is reached, the pressure is increased and the polymer may be extruded, cooled and cut into pellets.

More preferably, the poly(trimethylene terephthalate)s contain at least about 80 mole %, or at least about 90 mole %, or at least about 95 mole %, or at least about 99 mole %, of repeat units derived from 1,3-propanediol and terephthalic acid (or equivalent). The most preferred polymer is poly(trimethylene terephthalate) homopolymer (polymer of substantially only 1,3-propanediol and terephthalic acid or equivalent).

Poly(1,3-trimethylene 2,6-naphthalate) is also a component of the copolymer used, and it, too, can be made by using biologically-derived 1,3-propanediol. One way of making the poly(1,3-trimethylene 2,6-naphthalate) is to react it with dimethyl 2,6-naphthalenedicarboxylate under atmospheric pressure and nitrogen in the presence of a titanium tetraisopropoxide catalyst as described in U.S. Pat. No. 6,531,548.

Poly(1,3-trimethylene 2,6-naphthalate) can also be prepared by transesterification of a dialkyl ester of 2,6-naphthalene dicarboxylic acid and 1,3-propanediol or direct esterification of 2,6-naphthalene dicarboxylic acid and 1,3-propanediol followed by polycondensation.

For example, in a batch process, a C₁-C₄ dialkyl ester of 2,6-naphthalene dicarboxylic acid and 1,3-propanediol are reacted in an inert atmosphere such as nitrogen in a mole ratio of about 1:1.2 to about 1:3.0 in the presence of a transesterification catalyst at a temperature between about 170° C. and about 245° C. at atmospheric pressure to form a monomer and a C₁-C₄ alkanol corresponding to the C₁-C₄ alkanol components of the dialkyl ester of 2,6-dinaphthalene dicarboxylic acid. The C₁-C₄ alkanol is removed as it is formed during the reaction. Examples of transesterification catalysts include compounds of manganese, zinc, calcium, cobalt, titanium and antimony such as Mn(acetate)₂, Zn(acetate)₂, Co(acetate)₂, tetrabutyl titanate, tetraisopropyl titanate, and antimony trioxide. The resulting reaction product, comprising bis(3-hydroxypropyl) 2,6-naphthalate monomer and oligomers thereof, is then polymerized at temperatures between about 240° C. and about 280° C. under a reduced pressure of below about 30 mm Hg in the presence of a polycondensation catalyst, with removal of excess 1,3-propanediol, to form poly(1,3-trimethylene 2,6-naphthalate) having an inherent viscosity of about 0.2-0.8 deciliter/gram (dL/g). Examples of suitable polycondensation catalysts include compounds of antimony, titanium, and germanium such as antimony trioxide, tetrabutyl titanate, tetraisopropyl titanate. A titanium catalyst can be added prior to transesterification as both the transesterification and polycondensation catalyst. The transesterification and polycondensation reactions can also be carried out in continuous processes.

Polymers of different inherent viscosities can be produced with the same composition by varying the manufacturing or process conditions.

Other comonomers can be included during the preparation of the poly(1,3-trimethylene 2,6-naphthalate). For example, one or more other diol (other than 1,3-propanediol), preferably in an amount up to about 10 mole % based on total diol (including 1,3-propanediol and the other diol), and/or one or more other dicarboxylic acid (other than 2,6-naphthalene dicarboxylic acid and C₁-C₄ diesters thereof), preferably in an amount up to about 10 mole % based on the total diacid or dialkyl ester (including the 2,6-naphthalene dicarboxylic acid or C₁-C₄ dialkyl ester thereof and the other dicarboxylic acid or the C₁-C₄ dialkyl ester thereof) can be added before or during the esterification or transesterification reaction. Examples of comonomers which can be used include terephthalic acid or isophthalic acid and C₁-C₄ diesters thereof, and C₁-C₁₀ glycols such as ethylene glycol, 1,4-butanediol and 1,4-cyclohexane dimethanol.

The inherent viscosity of the poly(1,3-trimethylene 2,6-naphthalate) can be further increased using solid-phase polymerization methods. Particles of poly(1,3-trimethylene 2,6-naphthalate) having an inherent viscosity of about 0.2 to 0.7 dL/g can generally be solid-phased to an inherent viscosity of 0.7-2.0 dL/g by first crystallizing at a temperature of between about 165° C. and about 190° C. for at least 6 hours, preferably 12-18 hours, followed by solid-phase polymerizing under an inert atmosphere such as nitrogen purge at a temperature of between about 195° C. to about 220° C., preferably between about 195° C. to about 205° C., for at least 12 hours, preferably 16-48 hours. The solid-phase polymerization of the poly(1,3-trimethylene 2,6-naphthalate) particles may also be conducted under a vacuum of about 0.5 to 2.0 mm Hg.

The poly(1,3-trimethylene terephthalate) may have an inherent viscosity in the range between about 0.2 to about 2, 05 to about 1.5, or about 1.1 dL/g, preferably 0.5-0.9 dL/g. Similarly, the poly(1,3-trimethylene 2,6-naphthalate) may have an inherent viscosity in the film-forming range, generally between about 0.2 to about 1.0 dL/g or about 0.5 to about 0.9 dL/g.

This invention describes conditions under which physical blends of poly(1,3-trimethylene 2,6-naphthalate) and poly(1,3-trimethylene terephthalate) are subject to limited transesterification to form a film or oriented thin structure composed of a block copolymer containing small domains of high oxygen barrier poly(1,3-trimethylene 2,6-naphthalate) sequences. This enables the production of clear monolayer films in which the oxygen barrier can be increased by biaxial orientation followed by heat setting. It also demonstrates a composition at which the most cost-effective improvement is obtained. This allows the use of a small amount of expensive co-processible poly(1,3-trimethylene 2,6-naphthalate) to increase the barrier of poly(1,3-trimethylene terephthalate).

Heat setting normally may occur quickly and its completion may be defined as the point at which there is no further increase in density. The reason a different time might have an effect is related to thermal transmission inside the material. Once a given point reaches a temperature, the polymer is probably able to respond quickly to re-organize and after that there may be nothing more to be gained. The time for heat setting in a laboratory oven may be from 0.01 to about 10 minutes if the lab oven has no circulation. However, heat setting can happen very quickly on a commercial line that can get the hot air contact quickly and can be as short as seconds to one or two minutes.

Poly(1,3-trimethylene terephthalate) and poly(1,3-trimethylene 2,6-naphthalate) are co-processible polyesters based on 1,3-propanediol which can be made with biosourced materials, and are therefore partially renewable. Both of these polymers are related to poly(ethylene terephthalate), which is widely used in packaging, but both of these polymers individually have better O₂ and CO₂ barrier properties (measured by oxygen and carbon dioxide transmission, respectively) than poly(ethylene terephthalate). Poly(1,3-trimethylene terephthalate) has shown promise for use in packaging applications, but its barrier performance is not sufficient for that end-use. Stretching cannot be used to further improve its barrier properties due to the small difference between the glass transition temperature T_{g} and the cold crystallization temperature, T_{cc}. Poly(1,3-trimethylene 2,6-naphthalate) is a high performance polymer with some properties that are well-suited to packaging: it has high modulus, and high gloss with low haze and very low O₂ and CO₂ permeability, but its use in packaging applications is limited because of its relatively high cost. Table 1 summarizes the properties of poly(1,3-trimethylene terephthalate) and poly(1,3-trimethylene 2,6-naphthalate).

TABLE 1

| | poly(1,3- | poly(1,3- |
|---|---|---|
| | trimethylene | trimethylene |
| Property | terephthalate) | 2,6-naphthalate) |
| T_{g} (glass transition | 44 | 80 |
| temperature), ° C. | | |
| Tcc (cold crystallization | 70 | 170 |
| temperature), ° C. | | |
| Tₘ (melting temperature), ° C. | 227 | 204 |
| O₂ permeation | 5 | 0.8 |
| (cc-mil/100 in²-day) | | |

Physical mixing and blending of poly(1,3-trimethylene terephthalate) with poly(1,3-trimethylene 2,6-naphthalate) as described in U.S. Pat. No. 6,531,548 produces materials that are opaque. These blends have two glass transition temperatures (T_{g}'s) and two melting point temperatures (Tₘ's), which are similar to those of poly(1,3-trimethylene terephthalate) and poly(1,3-trimethylene 2,6-naphthalate).

Poly(1,3-trimethylene 2,6-naphthalate) may be present in the composition or blend from 1 to 45, 5 to 40, 10 to 40, or 20 to 40 wt %.

Any convenient extruder can be used. The polymers used may contain a small residue of transesterification catalyst from their initial manufacture. A transesterification catalyst such as those described above in the synthesis of poly(1,3-trimethylene 2,6-naphthalate) can be used to achieve transesterification during film extrusion in a shorter time or at a lower temperature. Without being bound by theory, the present invention, being a process that can achieve the desired blend without added catalyst, may provide an advantage since it may not require mixing a low-viscosity small-molecule catalyst with a high-viscosity polymer to achieve transesterification, thus avoiding the lack of process control likely to occur with poorly distributed catalyst during film extrusion.

Poly(1,3-trimethylene terephthalate) and poly(1,3-trimethylene 2,6-naphthalate) are blended in a desired ratio and fed through an extruder, such as a single-screw extruder, to produce films. Depending on the process conditions, the film produced is white/opaque as described in U.S. Pat. No. 6,531,548, or clear/transparent which is preferred for most packaging applications. Thermal analysis by differential scanning calorimetry (DSC) has shown that the white/opaque samples have two T_{g}'s, two Tₘ's and two crystallization temperatures (T_{cc}'s) indicating a physical blend of poly(1,3-trimethylene terephthalate) and poly(1,3-trimethylene 2,6-naphthalate). On the other hand, the clear/transparent samples show a single T_{g}, single T_{cc} and a Tₘ intermediate between the components, but because they are block copolymers, those values are different from those of the respective random copolymers described in academic literature.

Transesterification of poly(1,3-trimethylene terephthalate) and poly(1,3-trimethylene 2,6-naphthalate) has not been previously shown. During transesterification, covalent chemical bonds produced between these polymer chains at relatively high temperature and/or residence time render the blend miscible and produce clear, transparent films with the observed thermal properties. Random copolymers would be formed if the transesterification process was allowed to continue, but these random copolymers have not shown the optimum properties shown by the block copolymers of the present invention.

Block copolymers of 1,3-trimethylene terephthalate and 1,3-trimethylene naphthalate are produced by limiting the amount of transesterification. This amount is calculated by ¹H NMR as described in Jeong et al. Fibers and Polymers 2004 5(3) 245-251. In this method, the resonance between 4.5 and 5.0 ppm is used to determine the number-average sequence length and the degree of randomness of the copolymer. Based on the calculated number-average sequence lengths, the degree of randomness, “DR”, of the copolymers can be defined. By definition, DR=0 for a homopolymer mixture or virtually for a diblock copolymer, and DR=1 for a random copolymer. The average length of a sequence of poly(1,3-trimethylene terephthalate) units, “LTT”, and of a sequence of poly(1,3-trimethylene 2,6-napthalate) units, “LNN” is estimated, and the degree of randomness determined. The detection limit is a transesterification level of several percent, generally in the range of about 3% to 4%.

A limited degree of transesterification may unexpectedly render the samples clear and with a single Tg, Tcc or Tm. The degree of randomness of these materials is very low and long sequences of each component are present, indicating the formation of a block copolymer.

As the copolymer gets more random, the oxygen barrier contributed by the poly(1,3-trimethylene 2,6-naphthalate) domains is reduced/diluted. Therefore, it is desirable to have compositions with a DR of less than 0.15, preferably between about 0.03 and about 0.13, and NN sequences greater than 50 units long at 40 wt % poly(1,3-trimethylene 2,6-naphthalate), and greater than 10 units long at 20 wt % poly(1,3-trimethylene 2,6-naphthalate).

Once the copolymers are formed, and cast into films, the oxygen transmission rate (OTR) can be measured. The greater the OTR, the less of a barrier the film provides; therefore, lower OTR's are preferred for packaging applications since oxidation is a primary mechanism of degradation of quality of the packaged product. As shown in the examples below, the OTR of the copolymer blend films “as cast” is generally only slightly improved over a film cast from poly(1,3-trimethylene terephthalate) homopolymer. For polyesters to achieve maximum gas barrier properties (i.e., low OTR's), high crystallinity is preferred. However, the films produced by the process described herein are cooled rapidly at the exit of the extruder die, so the crystallinity in the cast films is generally low. Crystallinity can be increased by strain-induced crystallization at temperatures between T_{g} and T_{cc}, for example by biaxial orientation. Biaxial orientation can be achieved by stretching simultaneously in both directions on a Bruckner Karo IV Laboratory Stretching machine at a temperature above Tg but below Tcc, e.g., 70-80° C., at a rate of 9000%/min to a final stretch ratio of 3.0×3.0 to 3.5×3.5 compared to original dimensions. The biaxially-stretched film can then be heat-set under tension in any convenient way, e.g., a hot air oven at 170-180° C. for 5 minutes. However, under conditions of optimum heat transfer and temperature control, heat-setting can be accomplished within seconds, as would be expected on a commercial film line equipped with in-line hot air. The biaxially-stretched film is heat-set when it achieves the maximum density attainable at the heat-setting temperature.

The processes may enable strain-induced crystallization to be used to achieve the necessary barrier of poly(1,3-trimethylene terephthalate)/poly(1,3-trimethylene 2,6-naphthalate) blends. Poly(1,3-trimethylene terephthalate) is difficult to orient effectively because its T_{g} is close to its T_{cc}, so the film breaks due to fast crystallization before stretching is completed. Orientation must occur above T_{g} but below T_{cc}, which cannot be done in physical mixtures because the T_{cc} of poly(1,3-trimethylene terephthalate) is lower than the T_{g} of poly(1,3-trimethylene 2,6-naphthalate), as described in Table 1. Transesterification with poly(1,3-trimethylene 2,6-naphthalate) allows a wider orientation window because it increases the T_{cc} of poly(1,3-trimethylene terephthalate). Films which have no transesterification break when stretched due to fast crystallization of poly(1,3-trimethylene terephthalate). Conversely, poly(1,3-trimethylene 2,6-naphthalate) has excellent gas barrier at high crystallinity but crystallizes too slowly for most commercial processes. The presence of poly(1,3-trimethylene terephthalate) in the blend increases the crystallization rate of the poly(1,3-trimethylene 2,6-naphthalate).

Limiting transesterification may allow the conservation of long sequences of repeat units of the poly(1,3-trimethylene terephthalate) and poly(1,3-trimethylene 2,6-naphthalate). Domains rich in poly(1,3-trimethylene 2,6-naphthalate) possess lower oxygen permeability. Therefore, preserving the block structure maximizes the effect of the poly(1,3-trimethylene 2,6-naphthalate) so that lower amounts of this more expensive component may be used to reach the low oxygen permeability target for packaging applications.

Once the copolymer is extruded and biaxially stretched, it can be heat-set using any convenient method (e.g. a lab oven) at temperatures between the Tcc and Tm of the copolymer. The increased crystallization rate of poly(1,3-trimethylene 2,6-naphthalate) due to the presence of poly(1,3-trimethylene terephthalate) helps to enable short heat setting times to be used. As shown in the examples below, 20 weight percent of poly(1,3-trimethylene 2,6-naphthalate) is sufficient to achieve an O₂ barrier at 85% relative humidity (RH) comparable to biaxially oriented nylon, which is about 2.3 cc-mil/100 in²-day. Adding more poly(1,3-trimethylene 2,6-naphthalate) can increase cost. The barrier seen at 20 weight % poly(1,3-trimethylene 2,6-naphthalate) is better than the composition-weighted average of poly(1,3-trimethylene terephthalate) and poly(1,3-trimethylene 2,6-naphthalate), but this is not the case at higher loadings of poly(1,3-trimethylene 2,6-naphthalate).

The copolymers produced by the processes described herein find use in films with renewable or bioderived content in applications where an oxygen transmission rate of around 3 cc-mil/100 in²-day at 0% RH and 2.5 cc-mil/100 in²-day at 85% RH (both at about 20 wt % loading of poly(1,3-trimethylene 2,6-naphthalate), is needed. Assuming all the 1,3-propanediol used to make the homopolymers is bioderived, poly(1,3-trimethylene terephthalate) has a renewable content of about 36%, and similarly, the renewable content of poly(1,3-trimethylene 2,6-naphthalate) is about 29%. Therefore, the renewable content of the blends/copolymers is between about 29 and 36%.

Also disclosed is a process for reducing the oxygen or CO₂ permeation rate, i.e., increase the barrier to oxygen or CO₂, of a film can comprise contacting a poly(1,3-trimethylene terephthalate) and a poly(1,3-trimethylene 2,6-naphthalate) under a condition sufficient to produce a block copolymer. The film can comprise or be produced from poly(1,3-trimethylene terephthalate) and a poly(1,3-trimethylene 2,6-naphthalate) as disclosed above. The condition can also be the same as disclosed above.

The compositions may also find use in, for example, stretch-blow molding applications, injection molding applications, packaging films, and thermoforming where stress-induced orientation in thin structures containing (1,3-trimethylene 2,6-naphthalate) domains is also expected to be necessary to achieve sufficient barrier.

### EXAMPLES

### Test Methods

Optical transmittance was measured between 190 and 900 nm using a Varian Cary 100 Scan UV-Visible Spectrophotometer with a 70 mm diameter Labsphere DRA-CA-301 integrating sphere attachment as per ASTM E1175.

The melting point, crystallization temperature and glass transition temperature were determined using the procedure of ASTM D-3418, using a TA Instruments (New Castle, Del.) DSC (differential scanning calorimeter) Instrument Model 2100, with heating and cooling rates of 10° C./min.

Oxygen transmission rates of films at 0% (ASTM D3985) and 85% (ASTM F1927) RH were measured on a Mocon OX-TRAN® Model 2/21 at 23° C. after 3 hours conditioning and reported in cc-mil/100 in²-day.

Carbon-decoupled proton NMR spectra in deuterated chloroform (0.6 ml) with 8 drops of trifluoroacetic acid were collected at 600 MHz on a Bruker Avance 600 Spectrometer. The amount of transesterification was calculated from peak areas from these spectra using methods described in Jeong et al. Fibers and Polymers 2004 5(3) 245-251.

### Examples 1-8, and Comparative Examples A and B

The poly(1,3-trimethylene terephthalate) resin used was a homopolymer of 1,3-propanediol and dimethyl terephthalate with a melt point of about 230° C. and a nominal IV of about 1.1 dL/g, and supplied by DuPont as SORONA® Bright.

The poly(1,3-trimethylene 2,6-naphthalate) was prepared by reacting dimethyl 2,6-naphthalenedicarboxylate (DMN; 3000 kg) and 1,3-propanediol (1,3-PDO; 1315 to 1873 kg), to give a DMN/1,3-PDO mol ratio of 1.4 to 2 under atmospheric pressure of nitrogen in the presence of 1.2 to 1.6 kg of TYZOR® titanium tetraisopropoxide catalyst (64 to 85 ppm catalyst based on total weight of ingredients and catalyst) at 185° C. for 9 to 14 hrs. Methanol started to evolve and was removed as a condensate by distillation as it was formed for 4-5 hrs. The second step, polycondensation, was carried out for 3-5 hrs at 254° C., producing a polymer with an IV of 0.6 dL/g. Inherent viscosity was raised to 0.85 to 0.95 dL/g by solid-state polymerization in a Patterson-Kelly 100 cubic feet tube sheet tumble dryer/solid state polymerization unit for 48 hours at 190-195° C.

As shown in Table 2 below, pellets of both poly(1,3-trimethylene 2,6-naphthalate) and poly(1,3-trimethylene terephthalate) were mixed in the specified weight percent (weight % of poly(1,3-trimethylene 2,6-naphthalate)+weight % of poly(1,3-trimethylene terephthalate)=100 weight %) by manual mixing, and then dried overnight at 135° C. in a dessicant hopper drier. Nineteen-cm-wide sheets were cast using a 31.75 mm diameter 30/1 L/D single-screw extruder fitted with a 3/1 compression ratio single-flight screw with 5 L/D of a melt mixing section. There was a 120/150/120 square mesh screen on the breaker plate at the end of the extruder barrel. The extruder die was a 203-mm wide coat hanger type flat film die with a 0.38 mm die gap. The extruder was built by Wayne Machine (Totowa, N.J.). The molten polymer film exiting from the die was drawn down to nominally 0.3 mm thick as it was cast onto a 203 mm wide by 203 mm diameter double shell spiral baffle casting roll fitted with controlled temperature cooling water. The casting roll and die were built by Killion Extruders (Davis Standard, Cedar Grove, N.J.).

The opacity/transparency of the films produced was measured as described above, and the results are also shown in Table 2. Films with “% transmittance” less than 85% were considered opaque.

The amount of transesterification was calculated using the method described above. Values for each example, related to DR (degree of randomness) are found in Table 2. As shown in Table 2, a very limited degree of transesterification rendered the samples more transparent, and they had single T_{g}'s, T_{cc}'s or Tₘ's different from those of random copolymers. The degree of randomness was very low (as shown in the DR column) and relatively long sequences of each component were present (i.e., thus indicating the formation of a block copolymer with NN sequences >50 units long at 40 wt % poly(1,3-propylene 2,6-naphthalate), and >10 units long at 20 wt % poly(1,3-propylene 2,6-naphthalate)).

As shown in Table 2, no transesterification was detected at short extruder residence time for 40 wt % poly(1,3-trimethylene 2,6-naphthalate), which had a transmittance of 56% (considered opaque), and a DR of ND (zero) (Examples 5 and 7). When films were clear (having a transmittance around 90%, Examples 6 and 8) their DR was only 0.03 and 0.08. Example 6 gave a calculated value of TT sequences of 104 units long, and NN sequences 55 units long. This shows a low degree of randomness, i.e., the polymers are considered “blocky”. Random copolymers, on the other hand, would have DR of 1, and therefore the materials made in Examples 6 and 8 are far from random.

Similarly, at 20 wt % poly(1,3-trimethylene 2,6-naphthalate), a hazy (nearly transparent) sample with a transmittance of 80% had a DR of 0.03 (Example 1). Example 2 had a DR of 0.095, and had TT sequences 58 units long and NN sequences 13 units long. Increasing DR only slightly, to 0.095 and 0.13 produced clear films with transmittance of 90%.

TABLE 2¹

| Example | PTN | Temp | Time | Tg | Tcc | Tm | Trans | OTR1 | TOR2 | TT | NN | DR |
|---|---|---|---|---|---|---|---|---|---|---|---|---|
| A | 0 | 261 | 3.6 | 44 | 69 | 228 | 90 | 7.1 | 4.1 | | | |
| 1 | 20 | 277 | 3.6 | 49 | 82 | 226 | 80 | 6.1 | 4.1 | 194 | 41 | 0.03 |
| 2 | 20 | 273 | 6.2 | 50 | 88 | 224 | 90 | 5.7 | 4.2 | 58 | 13 | 0.095 |
| 3 | 20 | 290 | 3.6 | 48 | 86 | 225 | 89 | 6.6 | 4.5 | | | |
| 4 | 20 | 290 | 6.2 | 48 | 90 | 223 | 90 | 6.3 | 4.7 | 36 | 9 | 0.13 |
| 5 | 40 | 277 | 3.6 | 48 | 80 (124) | 205 (227) | 56 | 4.9 | 3.4 | ND | ND | ND |
| 6 | 40 | 274 | 6.2 | 51 | 1-3 | 225 | 88 | 6.2 | 3.8 | 104 | 55 | 0.03 |
| 7 | 40 | 294 | 3.6 | 46 | 76 (126) | 206 (228) | 56 | 5.6 | 3.8 | ND | ND | ND |
| 8 | 40 | 296 | 6.2 | 51 | 112 | 223 | 90 | 5.7 | 3.8 | 34 | 20 | 0.08 |
| B | 100 | 275 | 6.2 | 80 | 172 | 195 (204) | 88 | 2.9 | 1.9 | | | |

¹All temperature measurements in ° C.;
PTN, poly(1,3-trimethylene 2,6-naphthalate) in wt %;
Trans, optical transmittance in %;
OTR1, oxygen permeation in cc-mil/100 in²-day, measured at 0% RH;
OTR2, oxygen permeation in cc-mil/100 in²-day, measured at 85% RH;
TT, the sequence of poly(trimethylene terephthalate) expressed in monomer units;
NN, the sequence of poly(trimethylene 2,6-naphthalate) expressed in monomer units; and
DR, degree of randomness.

The crystallinity of the samples was then increased by strain-induced crystallization between T_{g} and T_{cc}, which is commonly practiced as biaxial orientation. The cast films were biaxially oriented on a Karo IV lab stretcher (Bruckner Maschinenbau GmbH, Siegsdorf, Germany) at a stretch ratio of 3.5×3.5 at 9,000%/min followed by heat-setting in lab oven. The oxygen transmission rate (OTR) was measured as described above for each sample. The results are found in Table 3.

TABLE 3¹

| Ex- | | | | | | | |
|---|---|---|---|---|---|---|---|
| ample | PTN | OTR 1 | OTR 2 | OTR3 | OTR 4 | OTR5 | OTR 6 |
| A | 0 | 7.1 | 4.1 | 5.4 | 3.0 | 4.8 | 3.6 |
| 5 | 20 | 6.3 | 4.5 | 3.8 | 2.6 | 3.1 | 2.3 |
| 9 | 40 | 5.7 | 3.8 | 3.4 | 2.6 | 2.7 | 2.1 |
| B | 100 | 2.9 | 1.9 | 1.4 | 1.0 | 0.9 | 0.7 |

¹All temperature measurements in ° C.;
PTN, poly(1,3-trimethylene 2,6-naphthalate in wt %;
Trans, optical transmittance in %;
OTR1, oxygen permeation in cc-mil/100 in²-day, measured at 0% RH;
OTR2, oxygen permeation in cc-mil/100 in²-day, measured at 85% RH;
OTR3, oxygen permeation for biaxially oriented film in cc-mil/100 in²-day, measured at 0% RH;
OTR4, oxygen permeation for biaxially oriented film in cc-mil/100 in²-day, measured at 85% RH;
OTR5, oxygen permeation for heat-set biaxially oriented film in cc-mil/100 in²-day, measured at 0% RH; and
OTR6, oxygen permeation for heat-set biaxially oriented film in cc-mil/100 in²-day, measured at 85% RH.

1. A composition comprising a block copolymer wherein
the block copolymer comprises or is produced from poly(1,3-trimethylene terephthalate) sequences and poly(1,3-trimethylene naphthalate) sequences with less than 50 wt % of poly(1,3-trimethylene naphthalate);
the poly(1,3-trimethylene terephthalate) has an inherent viscosity of about 0.5 to about 1.5 dL/g and the poly(1,3-trimethylene 2,6-naphthalate) has an inherent viscosity of about 0.2 to about 1.0 dL/g; and
the block copolymer has a degree of randomness of less than 0.15.

2. The composition of claim 1 wherein the poly(1,3-trimethylene terephthalate), the poly(1,3-trimethylene 2,6-naphthalate), or both is derived from a biological source.

3. The composition of claim 1 wherein the block copolymer has a degree of randomness of 0.3 to 0.15.

4. The composition of claim 2 wherein the block copolymer has a degree of randomness of 0.3 to 0.13.

5. The composition of claim 2 wherein a film produced from the composition has an optical transmittance of greater than about 85%.

6. The composition of claim 1 wherein the block copolymer is a reaction product of the poly(1,3-trimethylene naphthalate) and the poly(1,3-trimethylene naphthalate).

7. The composition of claim 5 wherein the block copolymer is a reaction product of the poly(1,3-trimethylene naphthalate) and the poly(1,3-trimethylene naphthalate).

8. An article comprising or produced from a composition wherein the composition is as characterized in claim 1.

9. The article of claim 8 wherein the poly(1,3-trimethylene terephthalate), the poly(1,3-trimethylene 2,6-naphthalate), or both is derived from a biological source.

10. The article of claim 9 wherein in the article is a biaxially oriented film or sheet.

11. The article of claim 10 wherein in the article is a heat set article having an oxygen permeation of between 3 and 7.5 cc-mil/100 in²-day at 1 mil thickness.

12. The article of claim 11 wherein in the article is has an oxygen permeation of 3 cc-mil/100 in²-day at 1 mil thickness.

13. A process comprising:
a) combining poly(1,3-trimethylene terephthalate) and poly(1,3-trimethylene 2,6-naphthalate) to form a blend comprising up to about 50 wt % poly(1,3-trimethylene 2,6-naphthalate);
b) feeding the blend into an extruder to produce a composition; and
c) extruding the composition at a temperature between about 275° C. and about 300° C. and a residence time of between about 3 to about 7 minutes to produce an article wherein
the poly(1,3-trimethylene terephthalate), poly(1,3-trimethylene 2,6-naphthalate), the composition and are each as characterized in claim 1.

14. The process of claim 13 wherein the extruding is carried out in the absence of a transesterification catalyst.

15. The process of claim 14 wherein the extruding is carried out under a condition that a transesterification occurs between the poly(1,3-trimethylene terephthalate) and the poly(1,3-trimethylene 2,6-naphthalate) at a level of about 0.5% to about 10%.

16. The process of claim 15 wherein the poly(1,3-trimethylene terephthalate), the poly(1,3-trimethylene 2,6-naphthalate), or both is derived from a biological source.

17. The process of claim 16 wherein the article is a film or sheet.

18. The process of claim 17 further comprising
d) stretching the article biaxially at a stretch ratio of greater than about 3.0×3.0 at 9,000%/min to produce a oriented article; and
e) heat-setting the oriented article at a temperature of between 150° C. and about 200° C. until maximum density is achieved.

19. The process of claim 18 wherein the article has an oxygen permeation at a relative humidity of 0% of between 3 and 7.5 cc-mil/100 in²-day and an optical transmittance of greater than about 85%.

20. The process of claim 19 wherein the process is carried out under a condition effective to reduce the oxygen permeation rate of the film or sheet as compared to a composition produced by mixing a poly(1,3-trimethylene terephthalate) and a poly(1,3-trimethylene 2,6-naphthalate).
